(19) United States
(12) Patent Application Publication
(10) Pub. No.: US 2016/0371664 A1
(43) Pub. Date: Dec. 22, 2016

(54) SLOTTED ROTATABLE DRUM AND METHOD OF USING SAME

(71) Applicant: NCR Corporation, Duluth, GA (US)

(72) Inventors: Robert John Suttie, Fife (GB); David Heighton, Fife (GB)

(21) Appl. No.: 14/744,816

(22) Filed: Jun. 19, 2015

(51) Int. Cl. G06Q 20/10; G07F 19/00

(52) U.S. Cl. CPC G06Q 20/1085; G07F 19/205

(57) ABSTRACT

A device, such as an automated teller machine, can include a shutterable aperture configured to receive deposit materials, such as cash and checks. The device can include a slotted rotatable drum located behind the shutterable aperture. During a transaction, when the aperture is unshuttered, the drum can be rotationally positioned to align the slot with the shutterable aperture, so that deposit materials pass through the aperture, then pass through the slot in the drum. Before and/or after a transaction, when the aperture is shuttered, the drum can be rotated in the same direction through several complete rotations, such as five or ten rotations. Used in this manner, the drum can detect and/or ensnare potential traps formed with hard and/or soft materials. If a trap prevents the drum from rotating, circuitry in the device can trigger an alert and take the device out of service.

### BACKGROUND

A device, such as an automated teller machine, can be subject to attack from fraudulent individuals. For example, a fraudulent individual can insert a trap into an automated teller machine, with the intent of capturing deposit materials, such as cash, that are deposited while the trap is in place. The fraudulent individual can set a trap on an automated teller machine, wait for a deposit to occur, then return to the automated teller machine and attempt to manipulate the trap to try and extract the deposit materials. The fraudulent individual can also set a trap on an automated teller machine that dispenses cash but does not accept deposits. For instance, when cash is presented to a customer, if the cash is not taken by the customer within a specified time period, the cash can be taken back into the machine and stored. A fraudulent individual can attempt to gain access to the cash by inserting a trap that can prevent the cash from being presented to the customer and further preventing the cash from being withdrawn into the machine. For the purposes of this document, such dispensed cash can be considered to be deposit materials. Typically, traps can be made from hard materials, such as aluminum and steel, and/or soft materials, such as dental floss and chewing gum.

### SUMMARY

A method can include rotating a drum within a housing through at least a first plurality of complete rotations in the same direction while a shutterable aperture on the housing remains shuttered. The method can include completing the rotation of the drum so that the drum has a first rotational position at which a slot extending through the drum has one end facing the aperture and has an opposing end facing away from the aperture.

An additional method can include receiving an initiation of a transaction at a user interface on a housing while a shutterable aperture on the housing remains shuttered. The method can include rotating a drum within the housing through at least a first plurality of complete rotations in the same direction while the aperture remains shuttered. The method can include completing the rotation of the drum so that the drum has a first rotational position at which a slot extending through the drum has one end facing the aperture and has an opposing end facing away from the aperture. The method can include unshuttering the aperture. The method can include receiving deposit materials from outside the housing through the aperture and through the slot on the drum; and shuttering the aperture.

A device can include a housing. The housing can define a shutterable aperture configured to receive deposit materials from outside the housing during a transaction. The device can include a drum disposed in the housing adjacent the aperture and defining a slot therethrough. The drum can be being rotatable to rotational positions including a first rotational position at which a slot extending through the drum has one end facing the aperture and has an opposing end facing away from the aperture.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 shows a side-view cross section of an example of a device including a slotted rotatable drum, in accordance with some embodiments.

FIGS. 2A and 2B show front and side views, respectively, of an example of the slotted rotatable drum from FIG. 1, in accordance with some embodiments.

FIG. 3 shows an example of a method for using a slotted rotatable drum, such as to detect and/or ensnare potential traps, in accordance with some embodiments.

FIG. 4 shows another example of a method for using a slotted rotatable drum, such as to detect and/or ensnare potential traps, in accordance with some embodiments.

### DETAILED DESCRIPTION

A device, such as an automated teller machine, can include a shutterable aperture configured to receive deposit materials, such as cash and checks. The device can include a slotted rotatable drum located behind the shutterable aperture. During a transaction, when the aperture is unshuttered, the drum can be rotationally positioned to align the slot with the shutterable aperture, so that deposit materials pass through the aperture, then pass through the slot in the drum. Before and/or after a transaction, when the aperture is shuttered, the drum can be rotated in the same direction through several complete rotations, such as five or ten rotations. Used in this manner, the drum can detect and/or ensnare potential traps formed with hard and/or soft materials. If a trap prevents the drum from rotating, circuitry in the device can trigger an alert and take the device out of service, thereby preventing an unsuspecting customer from depositing materials that could potentially be stolen by a fraudulent individual.

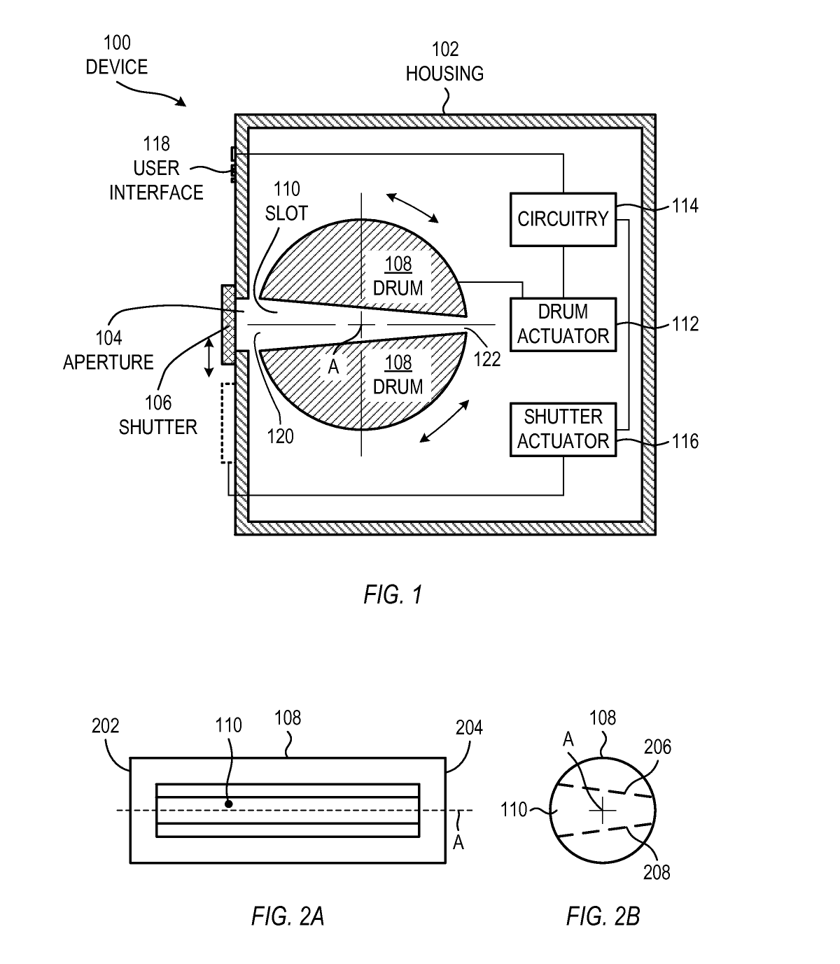

FIG. 1 shows a side-view cross section of an example of a device 100 including a slotted rotatable drum 108, in accordance with some embodiments. Examples of a suitable device can include an automated teller machine, a mail slot, and others. The configuration of FIG. 1 is but one example; other configurations can also be used.

Device 100 can include a housing 102. In some examples, the housing 102 can include a secured metal exterior, which can reduce or prevent tampering. Other suitable materials and configurations can also be used.

The housing 102 can define a shutterable aperture 104 configured to receive deposit materials from outside the housing 102 during a transaction. In some examples, the aperture 104 can be elongated. In some materials, the aperture 104 can be shaped as a slot.

In some examples, the shutterable aperture 104 can include a shutter 106 on the exterior or the interior of the housing 106. In some examples, the shutter 106 can translate away from the aperture 104, so that when the aperture 104 is unshuttered, the shutter remains parallel to its original orientation and is located laterally adjacent to the aperture 104. In other examples, the shutter 106 can rotate away from the aperture 104, so that when the aperture 104 is unshuttered, the shutter 106 is angled with respect to its original orientation.

A drum 108 can be disposed in the housing 102 adjacent the aperture 104 and defining a slot 110 therethrough. The drum 108 can be rotatable to rotational positions including a first rotational position at which the slot 110 extending through the drum 108 has one end 120 facing the aperture 104 and has an opposing end 122 facing away from the aperture. In some examples, the slot 110 and the aperture 104 can be elongated in the same direction. In some examples, the slot 110 can be shaped such that when the drum 108 is in the first rotational position, the slot 110 is wider at the end 120 facing the aperture 104 than at the end 122 facing away from the aperture 104, the width extending along a direction perpendicular to the elongation of the slot 110. In some examples, the drum 108 can be disposed directly adjacent to the aperture 104, with no intervening elements therebetween. In other examples, the drum 108 can be disposed adjacent to the aperture 104, with one or more intervening elements therebetween. In practice, the drum 108 can be close enough to the aperture 104 so that when deposit materials are entered into the aperture 104, the deposit materials pass easily through the aperture 104 into the slot 110, without significant risk of falling into a gap therebetween.

A drum actuator 112 can be disposed in the housing 102 and configured to controllably rotate the drum 108. In some examples, the drum actuator 112 can be configured to rotate the drum 108 around a central axis (A) of the drum 108. In some examples, the slot 110 can be elongated to match an elongation of the aperture 104, and the central axis (A) can be parallel to the direction of elongation. In other examples, the drum 108 can rotate around an axis laterally translated from the central axis (A), and/or skewed with respect to the central axis (A). In some examples, the drum actuator 112 can be disposed at one longitudinal end of the drum 108, with a bearing at an opposing longitudinal end of the drum 108. In some examples, the drum actuator 112 can be direct-driven. In other examples, the drum actuator 112 can be belt-driven. In some examples, the drum actuator 112 can be ratcheted, so that the drum actuator 112 can rotate the drum 108 in only one direction. In some examples, the ratchets can be in the drum actuator 112; in other examples, the ratchets can be disposed in a bearing.

Circuitry 114 can be configured to drive the drum actuator 112 so that the drum 108 rotates through at least a plurality of complete rotations in the same direction while the shutterable aperture 104 remains shuttered. Such rotation can beneficially ensnare or entangle traps made from soft material, such as dental floss. In some of these examples, the rotation can wind the dental floss around the circumference of the drum, so that neither end of the dental floss is accessible to a fraudulent individual through the aperture 104. In some of these examples, the rotation can tangle the dental floss. In some these examples, a trap placed in the slot by a fraudulent individual can block the drum actuator 112 from rotating the drum 108; the circuitry 114 can detect such a blockage, can trigger an alert, and can take the device 100 out of service. In some examples, the plurality of complete rotations can include between five and ten rotations, inclusive. In some examples, the plurality can include two, three, four, five, six, seven, eight, nine, ten, or more than ten rotations. The circuitry 114 can be further configured so that the drum actuator 112 completes the rotation of the drum 108 so that the drum 108 is in the first rotational position (e.g., with the slot 110 having one end facing the aperture 104 and an opposing end facing away from the aperture 104).

A shutter actuator 116 can be coupled to the circuitry 114 and configured to shutter and unshutter the aperture 104, such as by moving the shutter 106. When the shutter 106 is in the open position, the slot 110 can be exposed through the aperture 104 to receive the deposit materials. When the shutter 106 is in the closed position, the shutter 106 blocks the slot 110 from receiving the deposit materials.

A user interface 118 can be disposed on an exterior of the housing 102, coupled to the circuitry 114, and configured to initiate and conduct a transaction at the device 100. In some examples, the user interface 118 can include one or more buttons for receiving input from a user, such as a dollar amount and/or a personal identification number. In some examples, the user interface 118 can include a display facing the user. In some example, the display can be touch-sensitive.

FIGS. 2A and 2B show front and side views, respectively, of an example of the slotted rotatable drum 108 from FIG. 1, in accordance with some embodiments. The example in FIGS. 2A and 2B is but one example of a suitable rotatable drum; other suitable drums can also be used.

In some examples, the drum 108 can be coupled to the drum actuator 112 (FIG. 1) at one of its longitudinal ends 202, 204, and coupled to a bearing at the other of its longitudinal ends 202, 204.

In some examples, the walls 206, 208 of the slot 110 can be planar. In other examples, the walls 206, 208 can include concave or convex curvature. In some examples, the walls 206, 208 can be angled with respect to each other, so that the width of the slot 110 decreases from front-to-back, the width being measured in a direction perpendicular to an elongation of the slot 110. In some examples, the walls 206, 208 can be angled symmetrically, with respect to the central axis (A) of the drum 108. In other examples, the walls 206, 208 can be angled asymmetrically.

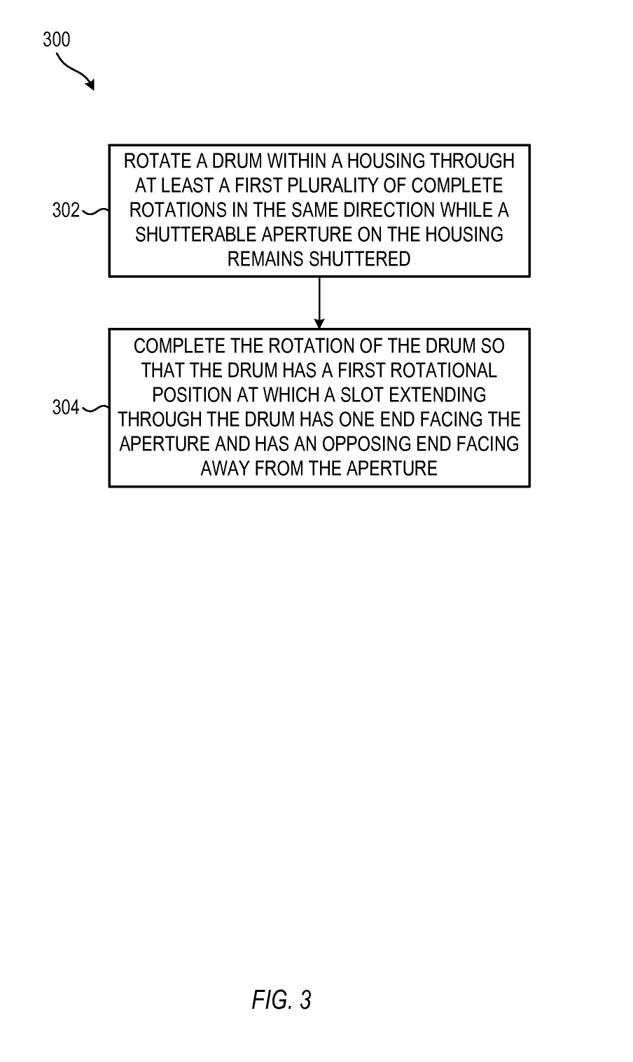

FIG. 3 shows an example of a method 300 for using a slotted rotatable drum, such as to detect and/or ensnare potential traps, in accordance with some embodiments. The method 300 is but one example of a method for using a slotted rotatable drum; other suitable methods can also be used. The method 300 can be executed by a device, such as 100 (FIG. 1), although other suitable devices can also execute the method 300.

At operation 302, the device can rotate a drum within a housing through at least a first plurality of complete rotations in the same direction while a shutterable aperture on the housing remains shuttered. In some examples, the first plurality of complete rotations can include between five and ten rotations, inclusive.

At operation 304, the device can complete the rotation of the drum so that the drum has a first rotational position at which a slot extending through the drum has one end facing the aperture and has an opposing end facing away from the aperture.

In some examples, the device can perform operations 302 and 304 at the beginning of a transaction, such as a cash deposit at an automated teller machine. In other examples, the device can perform operations 302 and 304 at the end of a transaction. In still other examples, the device can perform operations 302 and 304 both at the beginning and at the end of a transaction.

In some examples, the method 300 can further include operations of unshuttering the aperture, receiving deposit materials from outside the housing through the aperture and through the slot on the drum; and shuttering the aperture. In some of these examples, the unshuttering of the aperture, the receiving of the deposit materials, and the shuttering of the aperture can all be performed following the completing of the rotation of the drum. In some of these examples, the method 300 can further include, following the shuttering of the aperture, rotating the drum through at least a second plurality of complete rotations in the same direction while the shutterable aperture remains shuttered. In some of these examples, the method 300 can further include completing the rotation of the drum through at least the second plurality of complete rotations so that the drum has the first rotational position. In some of these examples, the first and second pluralities of complete rotations include between five and ten rotations, inclusive. In some examples, the method 300 can further include, before the drum is rotated, receiving an initiation of a transaction at a user interface on the housing while the shutterable aperture remains shuttered.

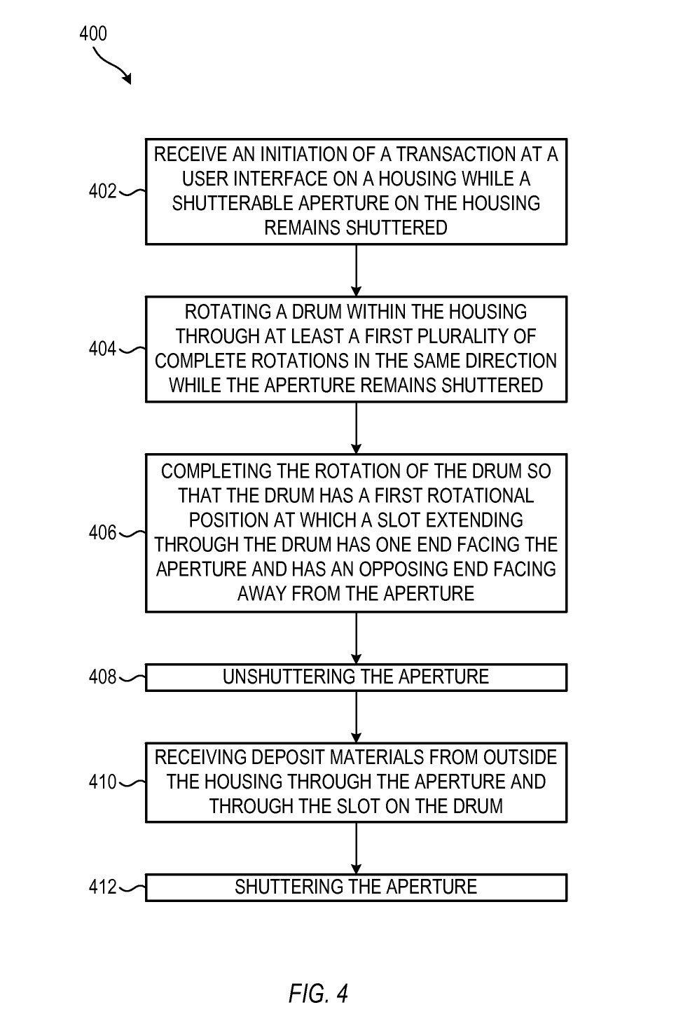

FIG. 4 shows another example of a method 400 for using a slotted rotatable drum, such as to detect and/or ensnare potential traps, in accordance with some embodiments. The method 400 is but one example of a method for using a slotted rotatable drum; other suitable methods can also be used. The method 400 can be executed by a device, such as 100 (FIG. 1), although other suitable devices can also execute the method 400.

At operation 402, the device can receive an initiation of a transaction at a user interface on a housing while a shutterable aperture on the housing remains shuttered.

At operation 404, the device can rotate a drum within the housing through at least a first plurality of complete rotations in the same direction while the aperture remains shuttered. In some examples, the first plurality of complete rotations can include between five and ten rotations, inclusive.

At operation 406, the device can complete the rotation of the drum so that the drum has a first rotational position at which a slot extending through the drum has one end facing the aperture and has an opposing end facing away from the aperture.

At operation 408, the device can unshutter the aperture.

At operation 410, the device can receive deposit materials from outside the housing through the aperture and through the slot on the drum.

At operation 412, the device can shutter the aperture.

In some examples, method 400 can further include, following the shuttering of the aperture, rotating the drum through at least a second plurality of complete rotations in the same direction while the aperture remains shuttered. In some of these examples, method 400 can further include completing the rotating the drum through at least the second plurality of complete rotations so that the drum has the first rotational position. In some of these examples, the second plurality of complete rotations can include between five and ten rotations, inclusive.

Some embodiments may be implemented in one or a combination of hardware, firmware and software. Embodiments may also be implemented as instructions stored on a computer-readable storage device, which may be read and executed by at least one data processing device to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, device 100 (FIG. 1) may include one or more processors or data processing devices and may be configured with instructions stored on a computer-readable storage device.

What is claimed is:

1. A method, comprising:
rotating a drum within a housing through at least a first plurality of complete rotations in the same direction while a shutterable aperture on the housing remains shuttered; and
completing the rotation of the drum so that the drum has a first rotational position at which a slot extending through the drum has one end facing the aperture and has an opposing end facing away from the aperture.

2. The method of claim 1, further comprising:
unshuttering the aperture;
receiving deposit materials from outside the housing through the aperture and through the slot on the drum; and
shuttering the aperture.

3. The method of claim 2, wherein the first plurality of complete rotations includes between five and ten rotations, inclusive.

4. The method of claim 2, wherein the unshuttering of the aperture, the receiving of the deposit materials, and the shuttering of the aperture are all performed following the completing of the rotation of the drum.

5. The method of claim 4, further comprising, following the shuttering of the aperture:
rotating the drum through at least a second plurality of complete rotations in the same direction while the shutterable aperture remains shuttered.

6. The method of claim 5, further comprising:
completing the rotation of the drum through at least the second plurality of complete rotations so that the drum has the first rotational position.

7. The method of claim 6, wherein the first and second pluralities of complete rotations include between five and ten rotations, inclusive.

8. The method of claim 1, further comprising, before the drum is rotated:
receiving an initiation of a transaction at a user interface on the housing while the shutterable aperture remains shuttered.

9. A method, comprising:
receiving an initiation of a transaction at a user interface on a housing while a shutterable aperture on the housing remains shuttered;
rotating a drum within the housing through at least a first plurality of complete rotations in the same direction while the aperture remains shuttered;
completing the rotation of the drum so that the drum has a first rotational position at which a slot extending through the drum has one end facing the aperture and has an opposing end facing away from the aperture;
unshuttering the aperture;
receiving deposit materials from outside the housing through the aperture and through the slot on the drum; and
shuttering the aperture.

10. The method of claim 9, wherein the first plurality of complete rotations includes between five and ten rotations, inclusive.

11. The method of claim 9, further comprising:
following the shuttering of the aperture, rotating the drum through at least a second plurality of complete rotations in the same direction while the aperture remains shuttered.

12. The method of claim 11, further comprising:
completing the rotating the drum through at least the second plurality of complete rotations so that the drum has the first rotational position.

13. The method of claim 12, wherein the second plurality of complete rotations includes between five and ten rotations, inclusive.

14. A device, comprising:
a housing, the housing defining a shutterable aperture configured to receive deposit materials from outside the housing during a transaction; and
a drum disposed in the housing adjacent the aperture and defining a slot therethrough, the drum being rotatable to rotational positions including a first rotational position at which the slot extending through the drum has one end facing the aperture and has an opposing end facing away from the aperture.

15. The device of claim 14, further comprising:
a drum actuator disposed in the housing and configured to controllably rotate the drum.

16. The device of claim 15, further comprising:
circuitry configured to drive the drum actuator so that the drum rotates through at least a plurality of complete rotations in the same direction while the shutterable aperture remains shuttered, the circuitry further configured so that the drum actuator completes the rotation of the drum so that the drum is in the first rotational position.

17. The device of claim 16, wherein the plurality of complete rotations includes between five and ten rotations, inclusive.

18. The device of claim 16, further comprising:
a shutter actuator coupled to the circuitry and configured to shutter and unshutter the aperture;
wherein when the shutter is in the open position, the slot is exposed through the aperture to receive the deposit materials; and
wherein when the shutter is in the closed position, the shutter blocks the slot from receiving the deposit materials.

19. The device of claim 14, wherein the aperture and the slot are elongated in the same direction.

20. The device of claim 19, wherein the slot is shaped such that when the drum is in the first rotational position, the slot is wider at the end facing the aperture than at the end facing away from the aperture, the width extending along a direction perpendicular to the slot elongation.
